(19) United States
(12) Patent Application Publication
(10) Pub. No.: US 2013/0301967 A1
(43) Pub. Date: Nov. 14, 2013

(54) METHOD FOR MOUNTING A ROLLING-ELEMENT BEARING SUPPORT MODULE, AND ROLLING-ELEMENT BEARING SUPPORT MODULE

(71) Applicants: Ingo Schulz, Gerolzhofen (DE); Michel Seubert, Schweinfurt (DE)

(72) Inventors: Ingo Schulz, Gerolzhofen (DE); Michel Seubert, Schweinfurt (DE)

(21) Appl. No.: 13/884,714

(22) PCT Filed: Nov. 3, 2011
(86) PCT No.: PCT/EP11/69271

§ 371 Date: Jul. 25, 2013

(30) Foreign Application Priority Data
Nov. 12, 2010 (DE) 10 2010 043 806.5

(51) Int. Cl. F16C 35/06

(52) U.S. Cl. CPC F16C 35/06
USPC 384/456; 29/898.07

(57) ABSTRACT

A method of mounting a rolling-element bearing support module on a machine having a shaft includes providing a rolling-element bearing support module having a support and a first rolling-element bearing for supporting the shaft, bringing the first rolling-element bearing with the rolling-element bearing support module up to the shaft so that the support abuts the end surface of the machine, rolling the shaft on at least a portion of a circumference of the bore, recording movement data of the shaft during the rolling, determining an alignment point based on the movement data, aligning the rolling-element bearing support module to the alignment point, and affixing the rolling-element bearing support module to the end side of the machine in the aligned position.

Exemplary embodiments of the present invention relate to a method for mounting a rolling-element bearing support module on a machine having a shaft, and to a rolling-element bearing support module for a machine, for example a compressor or a screw compressor.

With many machines, the degree of their efficiency and their functionality depends on the abidance to certain tolerances with regard to location and position of individual machine parts with respect to one another. This abidance to tolerances often decides, last but not least, whether a machine functions at all and whether it operates in the framework of its efficiency possibilities.

Compressors represent an example of this, wherein the alignment of their rotating parts relative to one another, but also to the stationary parts, has a very significant influence on their efficiency, with which the compressor operates. However this is by no means limited to compressors, but also applies to other machines, component assemblies and other components of complex mechanical systems.

Especially the alignment of rotating parts (e.g. shafts) to other rotating components or stationary housing or machine parts influences the long-term effectiveness and the efficiency of a machine. For this reason, in the development, design and manufacture of many complex machines, there is a great need to achieve a highest-possible alignment accuracy of shafts relative to other machine parts.

The object of the present invention is to provide a method and the constructive infrastructure necessary for this, which makes it possible to radially align a shaft of a machine as precisely as possible.

This object is achieved by a method for mounting a rolling-element bearing support module according to claim 1 or by a rolling-element bearing support module according to claim 7.

An exemplary embodiment of a method for mounting a rolling-element bearing module on a machine having a shaft, wherein the machine has an end surface and a bore in the end surface, into which the shaft of the machine at least partially extends, thus comprises the providing of a rolling-element bearing support module having a support and a first rolling-element bearing, which is formed to support the shaft. It further comprises the bringing of the rolling-element bearing with the rolling-element bearing support module up to the shaft, so that the support abuts the end surface of the machine. The shaft is rolled on at least a portion of a circumference of the bore, wherein movement data of the shaft are recorded. Based on this movement data an alignment point is determined, to which the rolling-element bearing support module is then aligned and affixed to the end side of the machine in the aligned position.

An exemplary embodiment of a rolling-element bearing support module for a machine comprises a support for mounting on a machine and a shaft of the machine, wherein the machine has an end surface and a bore in the end surface, into which the shaft at least partially extends. The rolling-element bearing support module comprises further a first rolling-element bearing, which is formed to support the shaft, wherein the support is further formed to be connectable to this in a plurality of mutually-displaceable positions to each other after the shaft is supported by the first rolling-element bearing, but before the connection to the end surface of the machine.

Exemplary embodiments of the present invention are based on the recognition that an improved alignment of a shaft in the radial direction in a bore of a machine can be achieved in that a bearing for the supporting of the shaft first is integrated in a rolling-element bearing support module, before this is attached in a laterally displaceable manner to an end surface of a machine, in which a bore is located; the rolling-element bearing support module is designed to be connectable to the end surface in more than one position. In this way, the exact position of the rolling-element bearing, and thus the exact position of the shaft relative to the bore can be set prior to the connection to the machine by a shifting of the rolling-element bearing support module on the end surface of the machine.

To this end, movement data of the shaft are recorded, while it rolls at least on a portion of a circumference of the bore, which can take place for example through a recording of the movement of a marked point of the shaft or of a movement range of the circumference of the shaft. In the case of recording the movement of a marked point, a center point of a circle can be determined, on which circle a center point of the shaft moves on an end surface thereof. In the case of collecting a movement range of the circumference of the shaft, this can take place for example through a corresponding collecting in two linearly independent directions, wherein respective average values are then determined from these measured motion ranges, from which an alignment point then results.

Technically, such a collecting of movement data can take place for example using optical methods, thus for example using laser measurement or using two-dimensional imaging. Mechanically, a collecting can be implemented for example using micrometer screws.

Methods for material-bonded or for friction-fit affixing can then be used for connecting the rolling-element bearing support module to the machine.

Exemplary embodiments of the present invention, however, are by no means limited to the use with machines having a single shaft. For the case that a machine includes, in addition to the previously mentioned shaft, a further shaft in a further bore, which likewise extends into the end surface of the machine, an exemplary embodiment of the present invention can further comprise the rolling of the further shaft on at least a portion of a circumference of the further bore and a recording of corresponding movement data, as well as a determining of a further alignment point based on the further movement data. In such a case it can likewise be advisable to design the rolling-element bearing support module in such a way that this also comprises a further rolling-element bearing, which can support the further shaft.

Exemplary embodiments of the present invention will be explained in more detail and described in the following with reference to the accompanying drawings and figures.

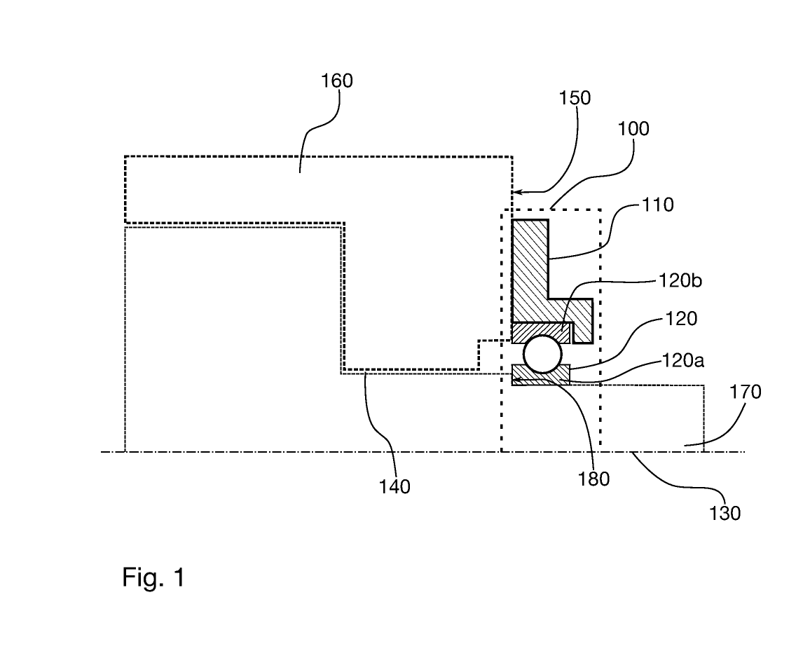

FIG. 1 shows a simplified cross-sectional view of a rolling-element bearing support module on a machine having a shaft according to an exemplary embodiment of the present invention;

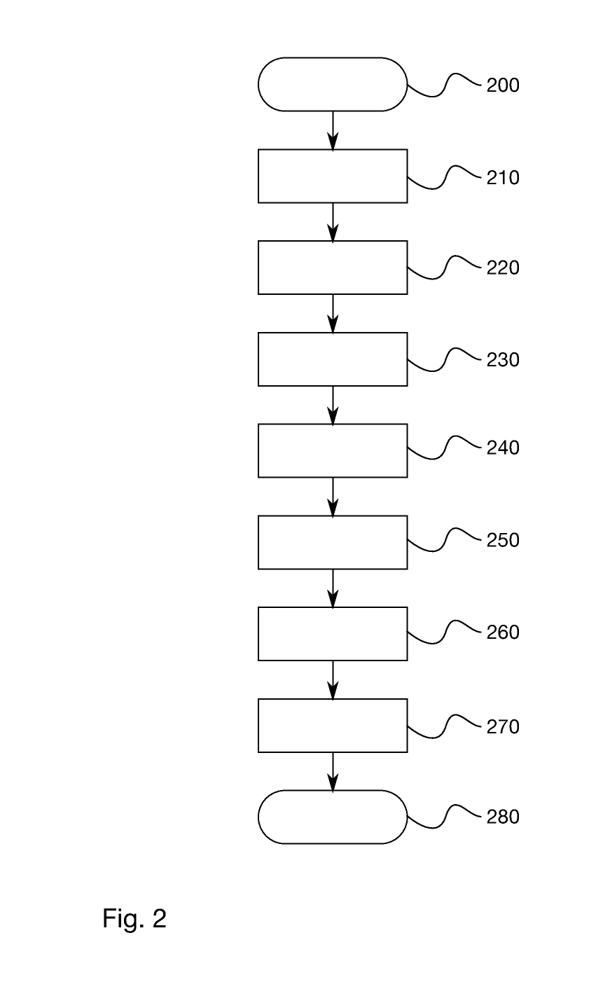

FIG. 2 shows a flow diagram of an exemplary embodiment of a method for mounting a rolling-element bearing support module on a machine;

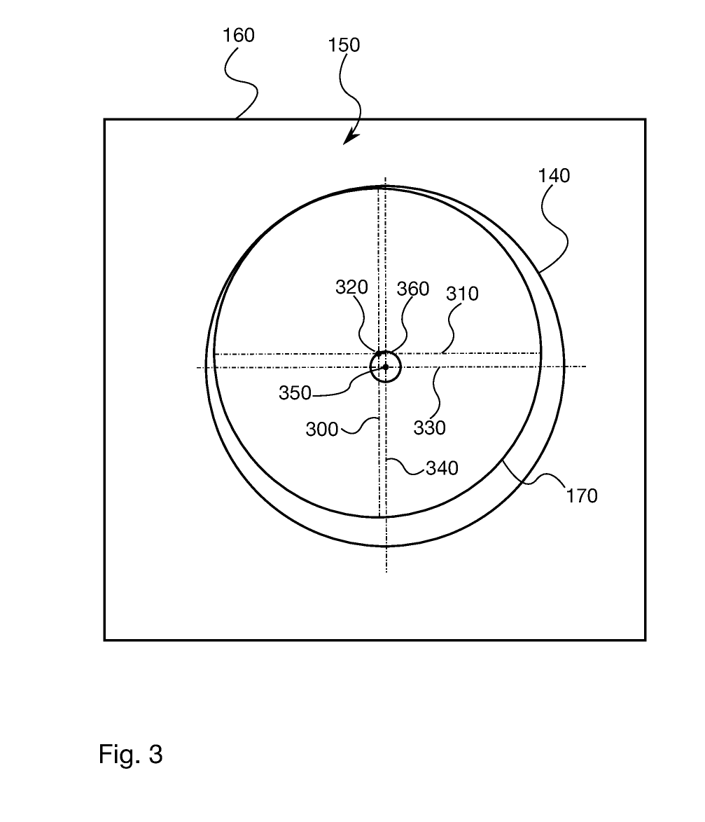

FIG. 3 shows a simplified view of a bore of a machine for illustrating the operation of an exemplary embodiment of the inventive method;

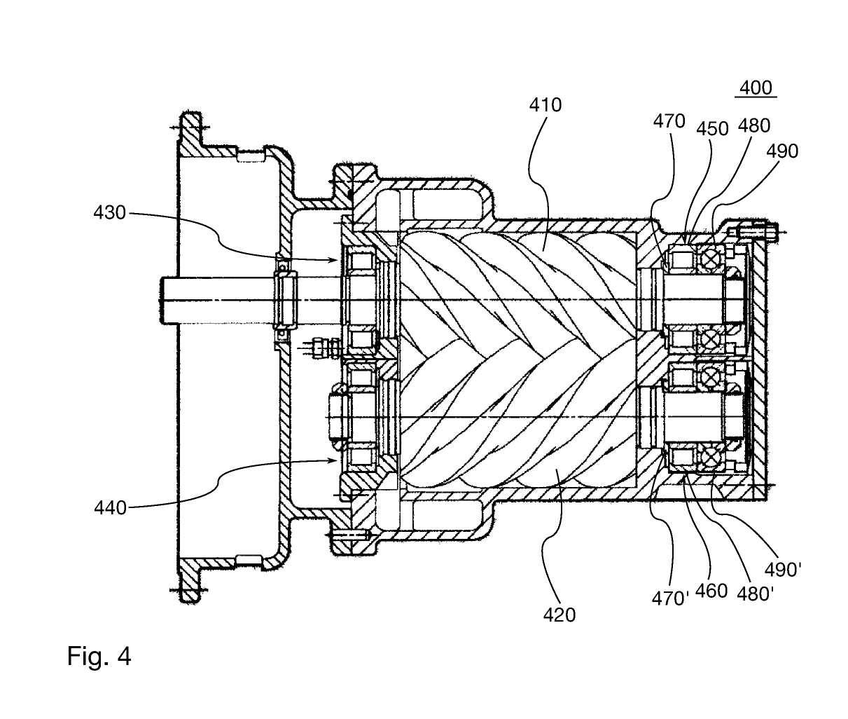

FIG. 4 shows a cross-section through a screw compressor;

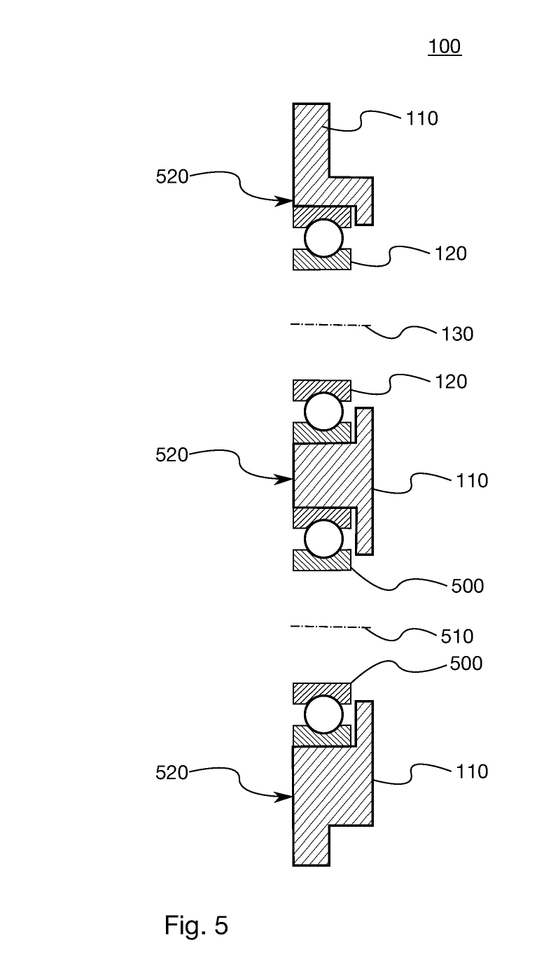

FIG. 5 shows a cross-sectional view of a rolling-element bearing support module according to an exemplary embodiment of the present invention for a machine having two shafts;

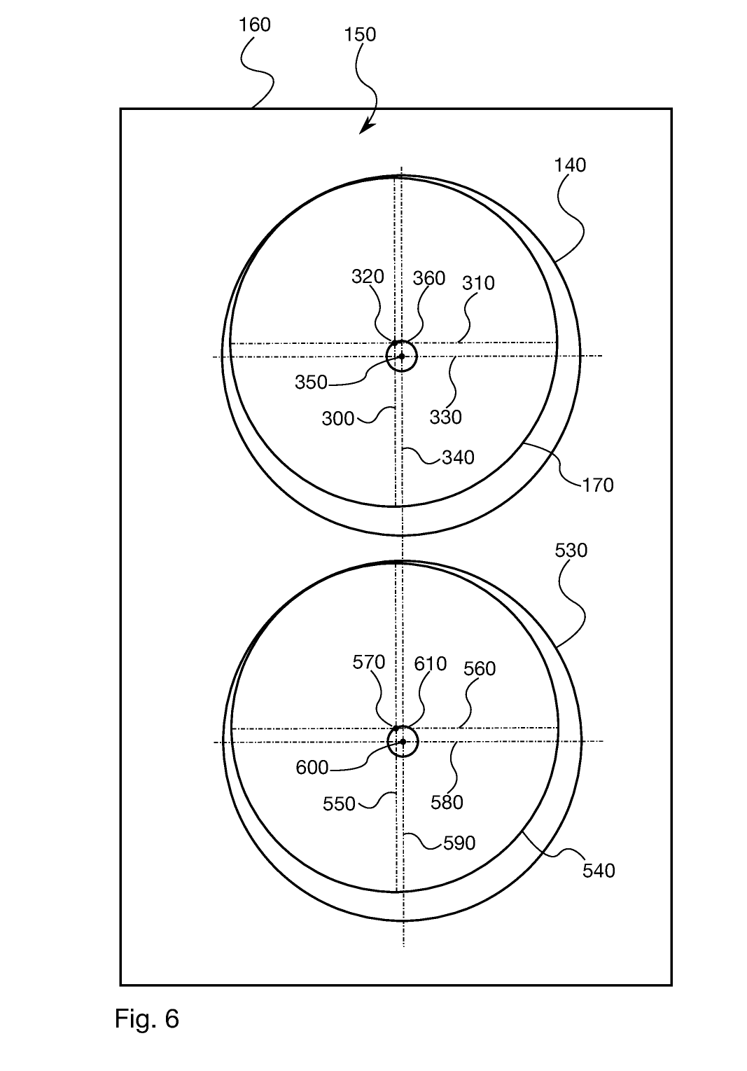

FIG. 6 illustrates the alignment and the operation of an exemplary embodiment of an inventive method for aligning a rolling-element bearing support module for the case of an alignment on a machine having two shafts; and

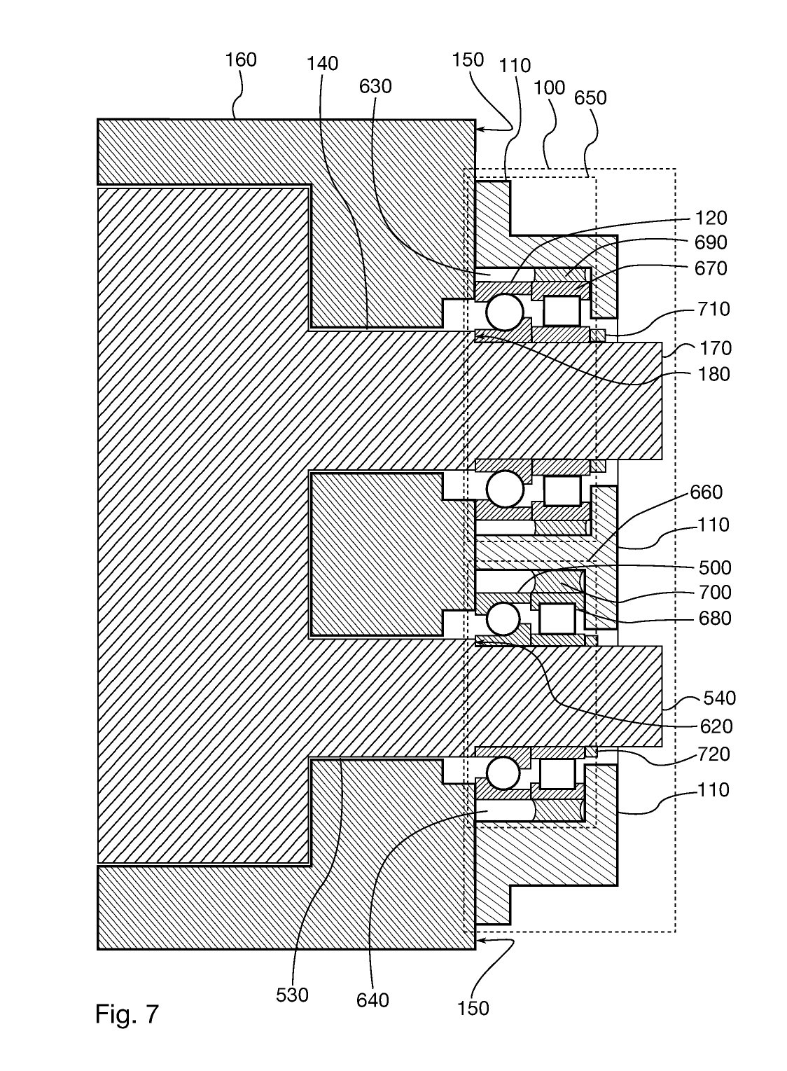

FIG. 7 shows a simplified cross-sectional diagram of a rolling-element bearing support module according to its exemplary embodiment of the present invention for a machine having two shafts, which further makes possible a simplified alignment of the shafts in the axial direction.

Before the present invention is to be explained and described in more detail in the context of FIGS. 1-7, it should be pointed out that exemplary embodiments of the present invention are usable with all machines in which an alignment of at least one shaft relative to a bore in the machine is advisable or necessary, even if in the further course of the present description, predominantly machines from the compressor field, such as compressors, screw compressors, and other machines for conveying gaseous or liquid media, are described. In principle, exemplary embodiments of the present invention are usable with all machines having axial bearings, which are to be positioned precisely, and abutment surfaces on the housing.

FIG. 1 shows a simplified illustration of a rolling-element bearing support module 100 according to an exemplary embodiment of the present invention. The rolling-element bearing support module 100 thus comprises a support 110 and a rolling-element bearing 120, which is illustrated in FIG. 1 as a ball bearing. The illustration used in FIG. 1 utilizes here a symmetry often at least partially present in exemplary embodiments of the present invention, which is however not mandatory. Thus only “one half” of the rolling-element bearing support module 100 and its components is shown in FIG. 1. A symmetry line 130 is shown in FIG. 1 in order to illustrate this in more detail. This symmetry results for example from the use of a bore 140 in an end surface 150 of a machine 160 or a part thereof. The part of the machine 160 can for example be a part of the housing or another component. However, a fully symmetrical design of a support module is not mandatory.

A shaft 170 extends in the bore 140, which shaft 170 has a narrowing on one of the sides facing towards the rolling-element bearing support module 100, which narrowing leads to the formation of an abutment surface 180 in the form of a shaft shoulder. In the illustration chosen in FIG. 1, the abutment surface 180 thus is aligned with the end surface 150 of the machine 160 in the case of an ideal alignment of the shaft 170.

The support 110 of the rolling-element bearing support module 100 thus abuts the end surface 150. An inner ring 120a of the rolling-element bearing 120 is in contact, with its side surface, with the abutment surface 180 of the shaft 170. An outer ring 120b of the rolling-element bearing 120 is in contact with the end surface 150 of the machine 160, and can thus, at least in an axial direction, transmit forces, which arise due to an axial movement of the shaft 170 by fitting the inner ring 120a on the shaft 170 and are conveyed through the rolling elements of the rolling-element bearing 120 (ball) and the outer ring 120b to the end surface 150 of the machine. The rolling element bearing 120 is thus in the position to transmit axial forces, at least in the direction which results from movement of the shaft towards the left, to the end surface 150 and thereby the machine 160. Simply to clarify that neither the machine 160 nor the shaft 170 belong to the rolling-element bearing support module 100, these are illustrated as dashed in FIG. 1.

After aligning and attaching the support 110 or the entire rolling-element bearing support module 100 by creating a friction-fit or material-bonded connection, radial forces can also be conveyed and imparted to the machine 160 via the rolling-element bearing 120 and the support 110.

FIG. 2 shows a flow diagram of an exemplary embodiment of a method for mounting a rolling-element bearing support module 100. After starting the method in step 200, a rolling-element bearing support module 100 having a support 110 and a first rolling-element bearing 120 is first provided, as it is illustrated for example in FIG. 1. In step 220 the rolling-element bearing 120 is then brought together with the rolling-element bearing support module 100 up to the shaft 170, so that the support 110 abuts the end surface 150 of the machine. In step 230 the shaft 170 subsequently rolls at least on a portion of a circumference of the bore 140, during which movement data of the shaft 170 are recorded in step 240. In step 250 an alignment point is then determined based on the thus-recorded movement data, based on which the rolling-element bearing support module 100 is aligned in step 260. In step 270 the rolling-element bearing support module 110 is subsequently affixed to the end side 150 of the machine 160 in the aligned position, before the method is ended in step 280.

FIG. 3 shows a view onto the end surface 150 of the machine 160, as it is shown in FIG. 1. For a better explanation of the method, as the flow diagram in FIG. 2 shows this, the rolling-element bearing support module 100 is not shown in FIG. 3.

FIG. 3 thus shows a view onto the end surface 150, which is located in the machine 160. FIG. 3 further shows the bore 140 in the end surface 150, wherein it can for example be a housing bore. FIG. 3 further shows a view onto an end surface of the shaft 170 as well as two symmetry lines 300, 310, which indicate the symmetry of the shaft 170. The axis of symmetry of the shaft 170 extends in the intersection point 320 of the symmetry lines 300, 310.

In addition, FIG. 3 also shows two mutually perpendicular symmetry lines 330, 340 of the bore 140, which intersect in their intersection point 350, through which the symmetry- or center-line of the bore 140 extends. In the case of a perfectly aligned shaft 170, the two intersection points 320, 350 of the shaft and the bore lie superimposed on one another. In this, the intersection point 350 can represent the alignment point of the method.

The bearing support module 100, which is in contact with the housing of the machine 160 in the axial direction via the abutment surface or end surface 150, which bearing support module 100 comprises the rotor bearing (rolling-element bearing 120), is freely movable radially during the mounting process, to the extent that the shaft 170 of the rotor allows. If the shaft or the rotor 170 is now rolled along the housing bore 140, a trace 360 of the central axis results, which coincides with the intersection point 320. This trace is measured and recorded for the purposes of steps 230 and 240. Provided that the shaft or the bore has no deviations from the circular shape with respect to their cross section, the circular trace 340 shown in FIG. 3 thus results. The central axis of the rotor can now be aligned based on these measurement data, and the bearing support module 100 can be fixed. The fixing between the bearing support module 100 and the compressor housing or machine housing 160 in the radial direction can be achieved through a material-bonded connection or also a friction-fit connection.

This mounting process thus permits the compensation of manufacturing tolerances, and thereby permits the fluctuation ranges to be minimized with the same manufacturing tolerances.

In other words, FIG. 3 shows an embodiment wherein the movement data of the center point of the shaft 170 are determined as a marked point. In the ideal case, circular cross sections of the bore 140 and the shaft 170 thus yield the circular trace 360 shown in FIG. 3, whose center point is to be determined and corresponds to the center point or the intersection point 350 of the symmetry lines 330, 340 of the bore 140.

In the alternative to determining the movement trace of a marked point on an end surface or another surface of the shaft 170, there is also the possibility to plot the movement range of the shaft 170 during the rolling along at least a portion of the circumference of the bore 140. In other words, there is the possibility to follow not a single point, but rather to determine an amplitude and/or elongation of the movement in at least two non-coincident directions. For example, if the movement is along the entire circumference of the bore 140, a center- or alignment-point can thus be determined by determining the average values of the corresponding ranges (elongation or amplitude) while considering the directions in which the determination is made. In this context it is important, however, that the two directions not be coincident, that is—in mathematical terms—not collinear, because otherwise at least one component of the alignment point in a plane defined by the end surface 150 is not determined.

Technically the recording of movement data of the shaft can take place for example optically or also mechanically. In the case of the recording of a marked point, for example a penetrating point of the axis of symmetry of the shaft through its terminal surface or end surface, an optical determination using laser measurement is thus possible, so that at the end of the shaft a laser is applied as precisely as possible to its center point, the light trace of the laser being followed using an optical recording system. Likewise, a suitable recording of the movement data can also take place using travel time measurements or using projection or disconnection. In addition, the movement of the shaft can be optically plotted in a simple manner using a camera mounted above the end surface 150 and automatically converted into corresponding movement data using a pattern recognition.

A recording of the movement data can take place mechanically through the use of micrometer screws, with the assistance of which either a marked point (e.g. a center point of the shaft 170) or also a movement range of the circumference can be determined.

As already explain above, after successful alignment, for example a friction-fit connection or material-bonded connection can be used in the region of the attachment of the rolling-element bearing support module 100 to the end side 150 of the machine 160. Thus for example—depending on the mechanical load of the rolling-element bearing support module 100—it can be friction-fit connected to the end surface using a clamping device. Likewise the rolling-element bearing support module can however also be adhered, soldered, or welded, in order to name only three examples of a material-bonded connection.

FIG. 4 shows a cross section through a screw compressor having a first screw shaft 410 and a second screw shaft 420 which, due to their screw-shaped shafts that are in mutual engagement, are mechanically permanently coupled. The screw compressor 400, as is shown in FIG. 4, has a locating/non-locating bearing arrangement with regard to the two screw shafts 410, 420, wherein a non-locating bearing 430, 440 is implemented on the left side in the form of a cylindrical roller bearing in each case. On the side shown to the right in FIG. 4, the two screw shafts 410, 420 each have a locating bearing arrangement 450, 460, wherein a cylindrical roller bearing is combined with a ball bearing in each case in order to mechanically implement the appropriate bearing property.

More specifically, the locating bearing assembly 450 comprises for example an intermediate ring 470 to be ground for radial clearance adjustment, to which ring 470 the cylindrical roller bearing 480 directly connects, and to which in turn the ball bearing 490 directly connects. The second screw shaft 420 also has a corresponding sequence of machine parts in the region of the locating bearing assembly 460. Here, an intermediate ring 470′ also connects directly to the cylindrical roller bearing 480′, which in turn is directly set onto a roller bearing 490′.

In contrast to exemplary embodiments of the present invention, such as have been previously described, with this conventional or conservative solution the radially-positioning bearings sit directly in the seats machined into the housing. The manufacturing-conditional offset of these seats relative to the housing bores, in which the rotors or shafts 410, 420 operate, as well as the tolerances of the diameters and widths of housing bores and rotor outer diameters lead to a tolerance addition, which directly affects the axial position of the motor. This can in turn lead to a reduction in the efficiency of the compressor 400. In order to nevertheless exactly set the axial position, the intermediate rings 470, 470′ are used. The required thickness of these intermediate rings is determined by mounting the bearings and rotors in the housing, measuring, subsequently dismounting and once again mounting with the customized, individually-ground intermediate rings 470, 470′.

Through the use of an exemplary embodiment of the present invention it is thus possible to simplify this very complex, double mounting procedure of the previously described standard solution.

FIG. 5 shows an exemplary embodiment of the present invention in the form of a rolling-element bearing support module 100, which is designed for the use of two shafts. In addition to a support 110, the rolling-element bearing support module 100 thus also comprises in turn a first rolling-element bearing 120, which in FIG. 5 is once again implemented as a ball bearing. The first rolling-element bearing 120 is once again here also only indicated with respect to a symmetry line 130.

However, in contrast to the rolling-element bearing support module 100 shown in FIG. 1, the rolling-element bearing support module 100 shown in FIG. 5 comprises a second rolling-element bearing 500, which is once again embodied as a ball bearing. The corresponding shaft for the second rolling-element bearing 500 is simply represented as symmetry line 510 and its position indicated accordingly. The support 110 of the rolling-element bearing support module 100 thus also has an abutment surface 520, which can be brought up to an end surface of a housing of a machine (not shown in FIG. 5) in such a way that, after the two shafts are supported by the two rolling-element bearings 120, 500, the rolling-element bearing support module 100 is positionable in different positions on the end surface not shown in FIG. 5 via the abutment surface 520.

FIG. 6 illustrates the situation wherein an exemplary embodiment of a method for mounting a rolling-element bearing module is performed in the case of a machine 160, which includes more than one shaft. It resembles FIG. 3 to a great extent, for which reason reference is made at this point to the description of FIG. 3. FIG. 6 thus shows once again a view of the end surface 150 of the machine 160, wherein for the sake of simplicity the rolling-element bearing module 100 is again not shown. The shaft 170 once again extends in the bore 140, wherein the symmetry lines 300, 310 and 330, 340 represent in their intersection points 320 and 350 respectively again the intersection points of the symmetry or center lines of the shaft 170 and the bore 140 through the drawing plane of FIG. 6. The drawing plane of FIG. 6 corresponds here to that of end surface 150.

In addition, however, FIG. 6 shows a further bore 530, in which a further shaft 540 extends. Symmetry axes of the shaft 540, which intersect in an intersection point 570, are also shown here by symmetry lines 550, 560, which intersection point 570 represents the intersection point of the symmetry line of the shaft 540 and the drawing plane shown in FIG. 6. Accordingly FIG. 6 also shows two symmetry lines 580, 590 of the bore 530, which intersect in an intersection point 600, which represents the intersection point of the symmetry line of the bore 530 and the drawing plane of FIG. 6.

If, as has already been described in the context of FIG. 3, the further shaft 540 now rolls on at least a portion of the circumference of the bore 530, the intersection 570 of the two symmetry lines 550, 560 of the further shaft 540 thus describes a trace 610, which extends in a circular shape around the intersection point 600 of the two symmetry lines 580, 590 of the further bore 530. If both a portion of the circumference, on which the shaft 170 rolls on the circumference of the bore 140, as well as the portion of the circumference, on which the further shaft 540 rolls, are sufficient to determine at least a portion of the respective traces 360, 610, in order to make clear the positions of the intersection points 350, 600 as alignment points, based on these two alignment points 350, 600, the rolling-element bearing support module not shown in FIG. 6 can now be aligned and subsequently affixed. In the case of ideal conditions it would thus be possible to align the rolling-element bearing support module on the end side 150 of the machine 160 such that the symmetry lines of the shafts 300, 310, 550, 560 coincide with those of the corresponding bores 330, 340, 580, 590, i.e. an “ideal alignment” of the rolling-element bearing support module will be achieved.

In an actual implementation, the achievement of such an ideal state is hardly probable already due to the manufacturing tolerances. As a result, it can be advisable in such a case to align the rolling-element bearing support module on the end surface 150 of the machine 160 using an optimization process such that a deviation from the previously described ideal position is minimized overall. For this purpose, various mathematical optimization methods or regression methods can be used. Thus, for example, the position of the rolling-element bearing support module can be set such that a sum of the distances of the intersection points 320, 570 from their ideal positions 350, 600 is minimized. Higher powers of the distances can also be incorporated into such a sum. Here for example a minimization of the linear, quadratic, or other polynomial distances is conceivable. In principle, however, other optimization methods are implementable.

FIG. 7 schematically shows a cross section through a corresponding machine 160, wherein it is a screw compressor. A conventional type of construction has already been shown in FIG. 4. However, the screw compressor 160 shown in FIG. 7 differs significantly from that shown in FIG. 4 due to the use of a rolling-element bearing support module 100 according to an exemplary embodiment of the present invention. The rolling-element bearing support module 100 once again includes a support 110 including a first rolling-element bearing 120, which is implemented as an angular contact ball bearing. The first rolling-element bearing 120 here guides a shaft 170, which extends entirely in a bore 140 of the machine 160. The shaft 170 here has an abutment surface 180, on which an inner ring of the first rolling-element bearing 120 abuts and is in contact with. The first rolling-element bearing 120 is additionally in contact with an end surface 150 of the machine 160 and is thus in the position to divert axial forces, which the shaft 170 generates in the case of a movement to the left, away via the first rolling-element bearing 120 to the end surface 150 of the screw compressor 160.

As has already been described in the context of FIG. 5, the rolling-element bearing support module 100 further includes a second rolling-element bearing 500, which is configured for bearing a further shaft 540 in a further bore 530 of the screw compressor 160. The second rolling-element bearing 500 is also implemented as an angular contact ball bearing 500 in the exemplary embodiment of a rolling-element bearing support module 100 shown in FIG. 7. Thus the shaft 540 also has a further abutment surface 620, which for example can be formed as a shaft shoulder or collar, with which the second rolling-element bearing 500 is in contact. The second rolling-element bearing 500 is also formed like the first rolling-element bearing 120, in order to transmit axial forces corresponding to a leftward movement of the further shaft 540 (in FIG. 7) to the end surface 150.

Thus both the first rolling-element bearing 120 as well as the second rolling-element bearing 500 are formed to support substantially axial forces in at least an axial direction, however essentially no radial forces. FIG. 7 shows this very fact, in that the support 110 has a clearance 630, 640 in the region of the first and the second rolling-element bearing 120, 500, respectively, in order to prevent a significant transmission of force to the support 110 in the radial direction.

The two shafts 170, 540 continue in the interior of the housing of the screw compressor to the corresponding rotors. The support module 100 thus forms the rotor bearing, which support module 100 abuts against the end surface 150 of the screw compressor 160 as an abutment surface in the axial direction for transmitting the axial forces.

However, in contrast to the exemplary embodiment shown in FIG. 5 of a rolling-element bearing support module 100, the rolling-element bearing support module 100 in FIG. 7 comprises a rolling-element bearing assembly 650, as well as a further rolling-element bearing assembly 660. The rolling-element bearing assembly 650 thus comprises inter alia the first rolling-element bearing 120, while the second rolling-element bearing assembly 660 comprises the second rolling-element bearing 500. However, since both the first rolling-element bearing 120 as well as the second rolling-element bearing 500 in the exemplary embodiment shown in FIG. 7 are formed only to support axial forces in at least one direction, the two rolling-element bearing assemblies 650, 660, comprise a first and/or second further rolling-element bearing 670, 680 for supporting the radial forces. These rolling-element bearings are cylindrical rolling-element bearings, which have flanges only on their outer rings for guiding the cylinders. Thus, in principle, they allow an axial displacement of the shaft by sliding the cylinders on the corresponding inner rings of the two further rolling-element bearings 670, 680 along the axial direction.

However, these two further rolling-element bearings each have a bearing casing 690, 700 for transmitting the radial forces to the support 110, so that the two rolling-element bearing assemblies 650, 660 can divert the radial forces, which occur, to the support 110 via these two bearing casings 690, 700. These thus “bridge” the two clearances 630, 640 of the two rolling-element bearings 120, 500.

In the exemplary embodiment shown in FIG. 7, a fastening ring 710, 720 forms an ending on the two shafts 170, 540, respectively, which should secure the seat of the bearing on the two shafts 170, 540 as an additional lock. These can be formed for example as shaft nuts, but also as adhered rings or as snap rings.

The rolling-element bearing support module 100, which is shown for example in FIG. 7, makes it possible to align the bearing support module relative to the rotor bearing in the radial direction by the previously described mounting method. In addition, the bearing support module makes it possible, as shown in FIG. 7, with this new type of bearing assembly, to evenly set an end gap in the rotor housing between the rotors and a corresponding housing end side facing towards the rotors. This setting of the end gap directly influences the efficiency of such a compressor. In order to realize a corresponding increase in efficiency using such a bearing assembly, it can now be advantageous to accordingly exactly position the bearing support module 100 not only in the axial direction, but also in the radial direction, by using an exemplary embodiment of the present invention.

The bearing assembly shown in FIG. 7 is part of a floating bearing assembly and thus differs from the locating/non-locating bearing assembly shown in FIG. 4. Depending on the particular implementation of a screw compressor or another machine 160, it can thus be advisable to also employ a corresponding, mirrored bearing assembly on the other side of the shaft. Alternatively, in exemplary embodiments of the present invention in the form of rolling-element bearing support modules, it can be thoroughly advisable to provide an additional rolling-element bearing support assembly, which comprises a third rolling-element bearing, wherein the additional rolling-element bearing assembly is formed to also support axial forces in the other axial direction and to apply or transmit them to the support via a first side surface of the additional rolling-element bearing assembly. A second side surface of the additional rolling-element bearing assembly can in this case lie free, wherein the second side surface of the additional rolling element bearing assembly opposes the first side surface of the additional rolling-element bearing assembly and the side surface of the original rolling-element bearing assembly. The additional rolling-element bearing assembly can be disposed here indirectly or directly adjacent in the axial direction to that of the first rolling-element bearing.

Of course, a rolling-element bearing support module 100 according to an exemplary embodiment of the present invention can also include more than one additional rolling-element bearing assembly.

In the assembly of the rolling-element bearing 650, 660 shown in FIG. 7, it remains to be mentioned that the arrangement of the angular contact ball bearing directly on the end surface 150 for supporting axial forces in at least one axial direction shortens a tolerance chain in the axial direction. Since commercially available angular contact ball bearings are often available with lower and/or finer width tolerances, corresponding angular contact ball bearings have been implemented as first rolling-element bearing 120 and second rolling-element bearing 500 in the exemplary embodiment shown in FIG. 7. Depending on the specific design it can therefore be useful to implement the first rolling-element bearing and optionally the second rolling-element bearing with a width tolerance of class PA4 or PA7 or also with a finer class, for example the classes PA9A or P9.

With regard to the order of carrying out the individual steps in the method for mounting rolling-element bearing support modules according to one of the exemplary embodiments of the present invention, it should be noted that the attachment of the rolling-element bearing before the rolling of the shaft on at least a portion of a circumference of the bore is feasible in principle, however this is far from necessary. Thus, under certain circumstances, it can be advisable to first perform the step of the rolling of the shaft and of the recording of the movement data during the rolling prior to the attaching of the rolling-element bearing or providing it. However, in some embodiments of a corresponding inventive method, the providing and attaching of the rolling-element bearing module prior to the performance of the rolling and the recording of the movement data can lead to a better and more precise alignment of the rolling-element bearing support module.

### REFERENCE NUMBER LIST

100 Rolling-element bearing support module
110 Support
120 First rolling-element bearing
130 Symmetry line
140 Bore
150 End surface
160 Machines
170 Shaft
180 Abutment surface
200-280 Method steps
300, 310 Symmetry lines
320 Intersection point
330, 340 Symmetry lines
350 Intersection points
360 Trace
400 Screw compressor
410 First screw shaft
420 Second screw shaft
430, 440 Non-locating bearing
450, 460 Locating bearing assemblies
470, 480 Intermediate rings
490 Ball bearing
500 Second rolling-element bearing
510 Symmetry lines
520 Abutment surface
530 Further bore
540 Further shaft
550, 560 Symmetry lines
570 Intersection point
580, 590 Symmetry lines
600 Intersection point
610 Trace
620 Further abutment surfaces
630, 640 Clearances
650 Rolling-element bearing assembly
660 Further rolling-element bearing assembly
670 First further rolling-element bearing
680 Second further rolling-element bearing
690, 700 Bearing casings
710, 720 Fastening rings

1. A method for mounting a rolling-element bearing support module on a machine having a shaft, wherein the machine has an end surface and a bore in the end surface into which the shaft of the machine at least partially extends, the method comprising:
providing a rolling-element bearing support module having a support and a first rolling-element bearing which is formed to support the shaft;
bringing the first rolling-element bearing with the rolling-element bearing support module up to the shaft, so that the support abuts the end surface of the machine;
rolling the shaft on at least a portion of a circumference of the bore;
recording movement data of the shaft during the rolling;
determining an alignment point based on the recorded movement data;
aligning the rolling-element bearing support module to the alignment point; and
affixing the rolling-element bearing support module to the end side of the machine in the aligned position,
wherein the recording of the movement data comprises recording a movement path of a marked point of the shaft or recording a movement range of a circumference of the shaft.

2. (canceled)

3. The method according to claim 1, wherein during the recording of the movement data of the marked point of the shaft, a center point of the shaft is on an end surface of the shaft, and wherein the determining of the alignment point comprises determining a center point of a circle, on which the marked point at least partially moves;
or
wherein the recording of the movement data comprises recording the movement range of the circumference of the shaft in at least two linearly independent directions, and wherein the determining of the alignment point comprises determining average values of the movement range for the at least two linearly independent directions.

4. The method according to claim 1, wherein the recording of the movement data of the shaft comprises an optical recording using laser measurement or using two-dimensional imaging, or a mechanical recording using micrometer screws.

5. The method according to claim 1, wherein the affixing of the rolling-element bearing support module comprises a material-bonded affixing or a friction-fit affixing.

6. The method according to claim 1, wherein, the machine comprises a further shaft in a further bore in the end surface of the machine, wherein the providing of the rolling-element bearing support module includes providing a rolling-element bearing support module with a second rolling-element bearing, which is formed to support the further shaft of the machine, wherein the second rolling-element bearing is connected to the support, wherein the method further comprises
rolling the further shaft on at least a portion of a circumference of the further bore;
recording movement data of the further shaft during the rolling;
determining a further alignment point based on the recorded movement data of the further shaft;
and wherein the aligning of the rolling-element bearing support module comprises an aligning to the further alignment point.

7. A rolling-element bearing support module for a machine comprising:
a support for mounting on a machine and on a shaft of the machine, wherein the machine has an end surface and a bore in the end surface, into which the shaft at least partially extends; and
a first rolling-element bearing, which is formed to support the shaft,
wherein the support is further formed to be connectable to the end surface of the machine in several mutually displaceable positions to each other, after the shaft is supported by the first rolling-element bearing, but before the connection with the end surface of the machine.

8. The rolling-element bearing support module according to claim 7, further including a second rolling-element bearing, which is formed to support a further shaft of the machine.

9. The rolling-element bearing support module according to claim 7, wherein the support is formed to be connectable in a friction-fit or material-bonded manner to the end surface of the machine.

10. The rolling-element bearing support module according to claim 7, further comprising a further rolling-element bearing, which is disposed in the axial direction, with reference to a center line of the first rolling-element bearing, indirectly or directly adjacent to the first rolling-element bearing, wherein a rolling-element bearing assembly comprises at least the first rolling-element bearing and the further rolling-element bearing, wherein the rolling-element bearing assembly is formed to support, via the first rolling-element bearing, axial forces in at least one axial direction, however essentially no radial forces, wherein the rolling-element bearing assembly is further formed to support radial forces via the further rolling-element bearing, however essentially no axial forces in the at least one axial direction, and transmit them to the support, wherein a side surface of the first rolling-element bearing is aligned with at least one of the planes corresponding to the end surface of the machine or a shaft surface of the shaft, wherein the shaft surface extends substantially parallel to the end surface of the machine, wherein the first rolling-element bearing is formed to transmit the axial forces in the at least one direction via the side surface to a component in the other plane corresponding to the end surface and the shaft surface, and wherein the further rolling-element bearing is disposed on a side of the first rolling-element bearing that faces away from the side surface of the first rolling-element bearing.

11. A method for aligning a shaft in a bore in an end surface of a machine, the method comprising:
providing a rolling-element bearing support module including a support member and a first rolling-element bearing configured to support the shaft;
placing the shaft in the bore;
rolling the shaft on at least a portion of a circumference of the bore;
recording a movement path of a marked point of the shaft or a movement range of a circumference of the shaft;
determining a relationship between the movement path of the marked point or the movement range of the circumference of the shaft and a center of the bore;
placing the rolling-element bearing support module on the shaft; and
after placing the rolling-element bearing support module on the shaft, moving the rolling-element bearing support module relative to the end surface of the machine to a position based on the determined relationship.

12. The method according to claim 11, wherein moving the rolling-element bearing support module comprises moving the rolling-element bearing support module to align a rotation axis of the shaft with the center of the bore.
